(19) United States
(12) Patent Application Publication
(10) Pub. No.: US 2026/0062151 A1
(43) Pub. Date: Mar. 5, 2026

(54) SYSTEM AND METHOD FOR INTEGRATED SELF-REPAIR IN AN AUTONOMOUS PLANETARY ROVER

(71) Applicant: Richard Joseph Mitchell, TAVARES, FL (US)

(72) Inventor: Richard Joseph Mitchell, TAVARES, FL (US)

(21) Appl. No.: 19/385,892

(22) Filed: Nov. 11, 2025

(51) Int. Cl. B64G 1/16; B64G 1/36; B64G 4/00

(52) U.S. Cl. CPC B64G 1/16; B64G 1/36; B64G 2004/005

(57) ABSTRACT

A system and method for autonomous self-repair of a planetary rover. The system comprises a health monitoring module, a multi-modal sensor suite, a robotic manipulator, a spare component storage bay, and an intelligent decision-making module. In response to receiving a fault signature, the decision-making module autonomously executes an end-to-end self-repair protocol. The protocol comprises: ceasing a primary mission; evaluating a current location of the rover against a predefined stability threshold; and, only if the current location is determined to be unstable, analyzing terrain data from the sensor suite to identify a previously un-mapped, ad-hoc stable location. The rover navigates to the stable location and, after confirming arrival, commands the manipulator to physically replace a failed hardware component with a spare. This integrated, fault-contingent protocol provides a new paradigm of autonomous self-preservation.

### 1. TECHNICAL FIELD

The present disclosure relates generally to the field of autonomous robotic systems and, more specifically, to a system architecture and method that enables an autonomous agent, such as a planetary rover, to perform physical self-repair in a remote, unstructured, and inaccessible environment where no external support or human intervention is possible.

### 2. BACKGROUND ART

The exploration of celestial bodies such as Mars relies on the long-duration, autonomous operation of robotic planetary rovers. These assets represent significant scientific and financial investments, but their operational lifespan is fundamentally limited by the reliability of their hardware components. The extraterrestrial environment is uniquely hostile, characterized by extreme thermal cycling, high radiation, and abrasive dust, which places immense stress on mechanical and electronic systems. Consequently, permanent hardware failure is an expected and mission-limiting event.

The traditional approach to reliability in space systems has focused on component hardening and passive redundancy. A system may carry “hot-spare” (powered) or “cold-spare” (unpowered) backup components. Upon a failure, a fail-operational protocol may switch control to a backup unit. While effective for certain failures, this paradigm is finite and cannot address the physical failure of a component for which no redundant unit exists, or a situation where all redundant units have been exhausted. In such cases, the rover's capability is permanently degraded or the mission is lost entirely.

A separate field of art has emerged to address the maintenance of space assets, known as on-orbit servicing, assembly, and manufacturing (OSAM). Programs such as DARPA's Orbital Express and Robotic Servicing of Geosynchronous Satellites (RSGS), along with commercial ventures, have demonstrated the use of robotic spacecraft to service other satellites. This entire body of prior art, however, is based on an external, servicer-client operational model. In this model, a dedicated “servicer” spacecraft is dispatched to provide services to a separate “client” satellite in a predictable, zero-gravity orbital environment. This two-body architecture is designed to solve the economic and logistical problem of servicing a fleet of assets in Earth orbit and does not address the unique challenges faced by a lone planetary rover.

Another field of art exists for automated, terrestrial maintenance within structured facilities. Systems such as those used at the National Ignition Facility (NIF) employ “auto-guided robotic vehicles” to transport, install, and maintain “line replaceable units” (LRUs). This art, however, relies on navigation within a controlled, structured environment (e.g., a laser bay) to and from predefined, pre-mapped “docking points”. This paradigm is fundamentally inapplicable to the challenges faced by a rover operating in complete isolation in an unstructured, unknown, and hazardous environment.

The prior art, focused on its two-body orbital servicing paradigm or its structured-facility maintenance model, does not teach or suggest a solution for the distinct problem of integrated self-sufficiency. Specifically, the prior art fails to address the critical need for a single, autonomous agent to navigate an unstructured, hazardous terrestrial surface to autonomously identify a previously un-mapped, ad-hoc stable location suitable for performing a delicate repair on itself. Therefore, there is a clear and unmet need for a new architectural paradigm—one of integrated self-sufficiency—that enables a single, autonomous agent to actively restore its own physical functionality to survive and complete its mission.

### BRIEF SUMMARY OF THE INVENTION

The present invention provides a system and method for an autonomous planetary rover capable of integrated physical self-repair. The invention departs from the passive redundancy of conventional rovers and the external, servicer-client model of the on-orbit servicing prior art. It is further distinct from terrestrial maintenance systems that rely on predefined “docking points”in structured environments.

The invention introduces a new paradigm of integrated self-preservation, wherein the rover itself possesses all necessary capabilities to autonomously diagnose, plan, and execute the physical replacement of its own failed hardware components in an unstructured environment. The protocol is not for general task-optimization, but is a reactive, fault-contingent protocol executed for the sole purpose of autonomous survivability.

In one aspect of the invention, a self-repairing autonomous planetary rover system comprises a chassis, a multi-modal sensor suite, a health monitoring module, a robotic manipulator, a storage bay containing spare Line Replaceable Units (LRUs), and an intelligent decision-making module.

The intelligent decision-making module is configured to execute an end-to-end autonomous self-repair protocol within the single rover system. This protocol is initiated only in response to receiving a fault signature indicating a permanent, critical hardware failure. Upon initiation, the decision-making module is configured to:
(1) cease primary mission operations;
(2) evaluate a current location of the rover against a predefined stability threshold;
(3) only in response to a determination that said current location is unstable for repair, analyze terrain data from the sensor suite to autonomously identify a previously un-mapped, ad-hoc stable location on the extraterrestrial surface having a surface slope below said predetermined threshold;
(4) command the rover to navigate to said identified ad-hoc stable location (if a new location was required);
(5) only after receiving a confirmation of arrival at a stable location, command the robotic manipulator to execute the physical replacement of the failed hardware component with a spare and
(6) command a diagnostic verification of the newly installed component before resuming the primary mission. This tightly integrated, contingent, and reactive end-to-end process within a single, isolated agent provides a new level of autonomous resilience not taught by the prior art.

### BRIEF DESCRIPTION OF THE SEVERAL VIEWS OF THE DRAWING

To facilitate a more complete understanding of the present invention, the following detailed description of the embodiments should be read in conjunction with the accompanying drawings, in which like elements are referenced with like numerals.

FIG. 1 is a block diagram illustrating the overall system architecture of the self-repairing autonomous planetary rover, in accordance with an embodiment of the present invention.

FIG. 2 is a block diagram illustrating the functional components and data flow of the intelligent decision-making module, in accordance with an embodiment of the present invention.

FIG. 3 is a flow diagram illustrating the logical steps of the end-to-end autonomous self-repair protocol, in accordance with an embodiment of the present invention.

FIG. 4 is a perspective view of an exemplary embodiment of the system on a planetary rover platform, showing the robotic manipulator in the process of replacing a failed wheel actuator Line Replaceable Unit (LRU).

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

### I. Overview of the Integrated Self-Sufficiency Paradigm

The present disclosure describes a system and method that provides a new level of resilience for autonomous planetary rovers. The architecture is founded on a paradigm shift from passive fault tolerance to a model of integrated self-sufficiency and autonomous self-repair. This capability is essential for multi-year missions in inaccessible environments where the probability of unrecoverable hardware failure approaches certainty and no external repair or servicing is possible. The invention integrates all necessary diagnostic, planning, navigation, and manipulation capabilities into a single, monolithic agent, enabling it to actively restore its own physical functionality.

### II. System Architecture of the Self-Repairing Rover

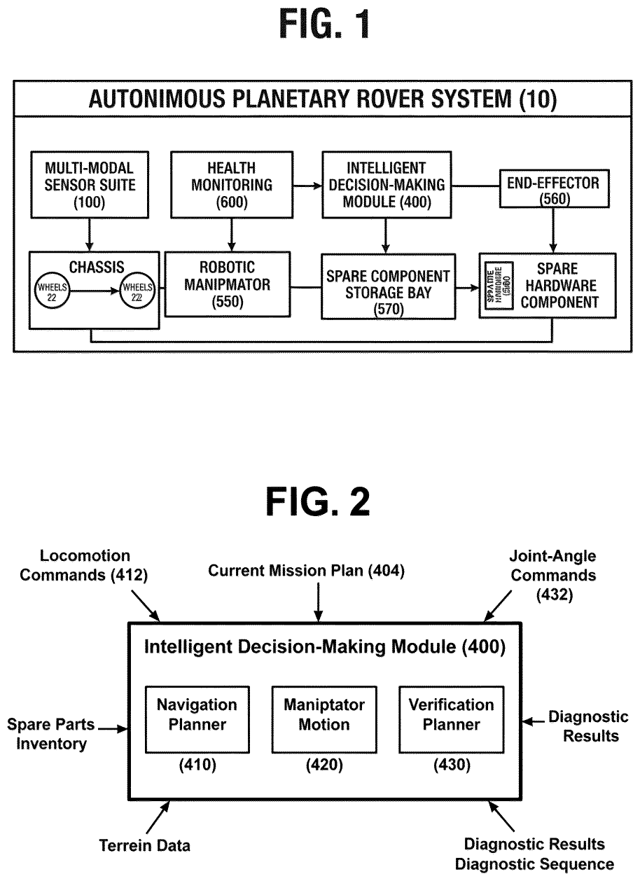

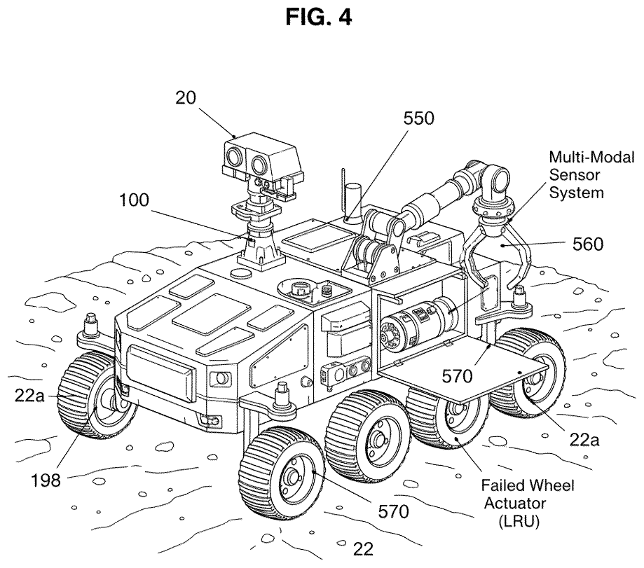

Referring to FIG. 1 and FIG. 4, the architecture is embodied in an autonomous planetary rover system (10). The system (10) comprises several interconnected modules.

A Chassis (20) provides the structural frame for the rover and is coupled to a locomotion system, such as a set of wheels (22).

A Multi-Modal Sensor Suite (100) is disposed on the chassis (20) and is configured for robust navigation and environmental awareness. In an embodiment, this suite (100) includes, without limitation, stereo navigation cameras, hazard avoidance cameras, LiDAR for 3D terrain mapping, and radiation-hardened Inertial Measurement Units (IMUs).

A Health Monitoring Module (600) is configured to continuously assess the operational status of all system components, including a first hardware component. The module (600) monitors parameters such as motor current, component temperature, and data integrity. Upon detecting a permanent, unrecoverable fault in the first hardware component, it is configured to generate a detailed fault signature.

At least one Robotic Manipulator (550) is coupled to the chassis (20). The manipulator (550) is equipped with an end-effector (560) designed to grasp, unlatch, and install hardware modules.

A Spare Component Storage Bay (570) is integrated into the chassis (20) and is configured to securely house one or more spare hardware components (580). In a preferred embodiment, the first hardware component and the spare hardware component (580) are designed as Line Replaceable Units (LRUs) with standardized mechanical and electrical interfaces to facilitate autonomous replacement.

An Intelligent Decision-Making Module (400) serves as the cognitive core of the system (10). It is communicatively coupled to the sensor suite (100), the health monitoring module (600), and the robotic manipulator (550) to control the rover's actions.

### III. Intelligent Decision-Making Module for Autonomous Repair

Referring to FIG. 2, the Intelligent Decision-Making Module (400) is a specialized computational unit configured to manage the complex, end-to-end self-repair protocol. To provide an enabling disclosure that satisfies the requirements of 35 U.S. C. § 112(a), the implementation of this module (400) is described herein with sufficient algorithmic detail to enable a person skilled in the art to make and use the invention without undue experimentation.

The module (400) can be implemented via a hierarchical planning system. Upon receiving a fault signature (402) from the Health Monitoring Module (600), a high-level planner assesses the fault against the current mission plan (404) and a spare parts inventory (406). If a repair is deemed necessary, the planner transitions the system state from “Executing Mission” to “Executing Repair.” This transition activates a series of specialized sub-planners.

A Navigation Planner (410) receives terrain data (408) from the sensor suite (100) and generates a safe trajectory to a suitable repair location. The algorithm executed by the Navigation Planner (410) comprises the following steps
(a) fusing sensor data from the LiDAR and stereo cameras to generate a 3D local terrain map, represented as a point cloud or elevation grid;
(b) segmenting the map into discrete surface patches of a minimum required size sufficient to accommodate the rover;
(c) for each patch, calculating key stability metrics, such as maximum slope, average slope, and surface roughness;
(d) comparing these metrics against predefined safety thresholds (e.g., maximum slope <5 degrees);
(e) selecting the closest patch that meets all safety thresholds as the target repair location; and
(f) generating a collision-free trajectory to that target using a standard pathfinding algorithm, such as A*, on a 2D occupancy grid derived from the terrain map. It outputs locomotion commands (412) to the rover's control system.

A Manipulator Motion Planner (420), once the rover is stationary at the repair site, generates a collision-free path for the robotic manipulator (550). The algorithm executed by the Manipulator Motion Planner (420) comprises the following steps: (a) using a known kinematic model of the manipulator (550) and a 3D geometric model of the rover system to define the robot's workspace and identify self-collision constraints; (b) defining start and goal configurations for the manipulator's end-effector (560) corresponding to the locations of the failed component (e.g., a wheel actuator 22a), the spare component (580) in the storage bay (570), and intermediate waypoints; (c) utilizing a sampling-based motion planning algorithm, such as a Rapidly-exploring Random Tree (RRT) (21) or Probabilistic Roadmap (PRM) algorithm, to find a valid, collision-free path in the manipulator's joint space between the start and goal configurations; and (d) smoothing the resulting path and converting it into a timed sequence of joint-angle commands (422) for the manipulator's controller.

A Verification Planner (430), after the manipulator (550) has completed the installation, commands the Health Monitoring Module (600) to execute a diagnostic sequence (432) on the new component. It receives the diagnostic results (434) and, if successful, transitions the system state back to “Executing Mission”.

### Iv. End-to-End Autonomous Self-Repair Protocol in Operation

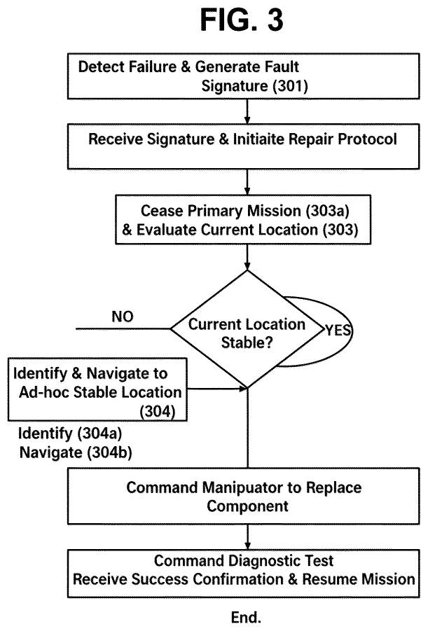

Referring to FIG. 3, an exemplary method of the inventive self-repair protocol is illustrated in the context of a critical wheel actuator failure on a planetary rover.

At Step (301), the Health Monitoring Module (600) detects a permanent failure in a first hardware component, such as a wheel actuator, and generates a fault signature.

At Step (302), the Intelligent Decision-Making Module (400) receives the signature, determines the rover cannot continue its primary mission objective (e.g., a scientific traverse), confirms a spare hardware component is available, and decides to initiate the self-repair protocol.

At Step (303), the protocol begins by ceasing the primary mission objective (Step 303a). The module (400) then commands The Navigation Planner (410) to evaluate the rover's current location against the predefined stability metrics (e.g., surface slope<5 degrees) using current data from the sensor suite (100).

At Step (304), only in response to a determination that the current location is unstable and fails to meet the safety thresholds, the Navigation Planner (410) is commanded to execute its full search algorithm (as described in Section III) to analyze the surrounding terrain data. It identifies the closest, previously un-mapped, ad-hoc stable location (Step 304a) and commands the rover to navigate to this new location (Step 304b). If, at Step (303), the current location is determined to be stable, this search and navigation step is bypassed entirely.

At Step (305), once the rover is confirmed to be stationary at a stable location (either its current location or the new ad-hoc location), the Manipulator Motion Planner (420) is activated. It commands the robotic manipulator (550) through the full replacement sequence, which may include unlatching the failed component, removing it, retrieving the spare (580) from the storage bay (570), and installing the new component, as depicted in FIG. 4.

At Step (306), the Verification Planner (430) commands a diagnostic test on the newly installed component to verify a successful repair.

At Step (307), upon receiving confirmation of a successful repair, the module (400) clears the fault and commands the rover to resume its primary mission objective.

This entire process, from fault detection to mission resumption, is performed autonomously by the single rover agent.

What is claimed is:

1. A self-repairing autonomous planetary rover system for operation in an unstructured extraterrestrial environment, comprising:
a. a chassis configured for traversing an unstructured extraterrestrial surface;
b. a multi-modal sensor suite disposed on the chassis and configured to generate terrain data corresponding to the unstructured extraterrestrial surface;
c. a health monitoring module configured to monitor a health status of a first hardware component of the system and, upon detecting a fault, to generate a fault signature;
d. a robotic manipulator coupled to the chassis;
e. a storage bay coupled to the chassis and configured to house a spare hardware component; and
f. an intelligent decision-making module communicatively coupled to the health monitoring module, the sensor suite, and the robotic manipulator, the decision-making module configured to:
i. receive said fault signature; and
ii. only in response to receiving said fault signature, autonomously execute an end-to-end self-repair protocol within the single rover system, the protocol comprising:
(a) ceasing a primary mission objective of the rover;
(b) evaluating a current location of the rover against a predefined stability threshold, wherein said stability threshold defines a location as unstable for said physical replacement;
(c) in response to a determination that said current location is unstable, analyzing said terrain data from the multi-modal sensor suite to autonomously identify a previously un-mapped, ad-hoc stable location on the unstructured extraterrestrial surface having a surface slope below said predetermined threshold;
(d) commanding the rover to navigate to said identified ad-hoc stable location; and
(e) only after receiving a confirmation of arrival at said identified ad-hoc stable location, commanding the robotic manipulator to physically replace the first hardware component with the spare hardware component retrieved from the storage bay.

2. The system of claim 1, wherein the intelligent decision-making module is further configured to, after the robotic manipulator has, at step (e), replaced the first hardware component, command the health monitoring module to perform a diagnostic test on the spare hardware component to verify a successful repair.

3. The system of claim 2, wherein the intelligent decision-making module is further configured to, only upon verification of the successful repair, command the rover to resume the primary mission objective.

4. The system of claim 1, wherein the first hardware component is a wheel actuator.

5. The system of claim 1, wherein the first hardware component and the spare hardware component are Line Replaceable Units (LRUs) having standardized mechanical and electrical interfaces.

6. The system of claim 1, wherein commanding the robotic manipulator to physically replace the first hardware component at step (e) comprises commanding the manipulator to perform a sequence of actions including unlatching the first hardware component, removing the first hardware component from the chassis, retrieving the spare hardware component from the storage bay, and installing the spare hardware component onto the chassis.

7. A method for providing autonomous self-repair of a planetary rover operating in an inaccessible, unstructured environment, the method comprising:
a. continuously monitoring, via a health monitoring module on the rover, a health status of a first hardware component of the rover;
b. upon detecting a fault in the first hardware component, generating, via the health monitoring module, a fault signature;
c. receiving, at an intelligent decision-making module on the rover, the fault signature; and
d. only in response to receiving the fault signature, autonomously executing, via the intelligent decision-making module within the single rover, an end-to-end self-repair protocol, the protocol comprising:
i. ceasing a primary mission objective of the rover;
ii. evaluating a current location of the rover against a predefined stability threshold, wherein said stability threshold defines a location as unstable for a physical repair;
iii. in response to a determination that said current location is unstable for said physical repair, autonomously identifying, via the intelligent decision-making module, a previously un-mapped, ad-hoc stable location on the unstructured extraterrestrial surface by analyzing terrain data from a sensor suite, said ad-hoc stable location having a surface slope below said predetermined threshold;
iv. navigating the rover to said identified ad-hoc stable location; and
v. only after confirming arrival at said identified ad-hoc stable location, commanding a robotic manipulator on the rover to physically replace the first hardware component with a spare hardware component.

8. The method of claim 7, wherein the protocol further comprises, after replacing the first hardware component at step (v), performing, via the health monitoring module, a diagnostic test on the spare hardware component to verify a successful repair.

9. The method of claim 8, wherein the protocol further comprises, only upon verification of the successful repair, commanding the rover to resume the primary mission objective.

10. The method of claim 7, wherein commanding the robotic manipulator to physically replace the first hardware component at step (v) comprises commanding the manipulator to:
a. unlatch and remove the first hardware component from a rover chassis;
b. retrieve the spare hardware component from a storage location on the rover; and
c. install the spare hardware component onto the rover chassis.

11. The method of claim 7, wherein the first hardware component is a sensor mast assembly, a wheel actuator, or a power distribution unit.

12. The method of claim 7, wherein the step of autonomously identifying at step (iii) comprises analyzing terrain data by fusing data from a LiDAR and a stereo camera to generate a 3D terrain map and calculating surface slope for discrete patches within said map.
